(19) United States
(12) Patent Application Publication
(10) Pub. No.: US 2026/0273482 A1
(43) Pub. Date: Sep. 17, 2026

(54) MODULAR MESH COMPONENT FOR FOAMING DISPENSERS AND TOOLING AND METHODS FOR MANUFACTURING THE SAME

(71) Applicant: RIEKE PACKAGING SYSTEMS LIMITED, Leicester (GB)

(72) Inventors: Raffaele ZANDONÀ, Padova (IT); Arianna GIRARDELLO,, Vicenza (IT); Simon C. KNIGHT, Bridgend, South Wales (GB)

(21) Appl. No.: 19/472,189

(22) PCT Filed: Apr. 5, 2024
(86) PCT No.: PCT/EP2024/059395

§ 371 Date: Oct. 3, 2025

(30) Foreign Application Priority Data
Apr. 5, 2023 (IT) 102023000006747

(51) Int. Cl. B01F 25/452; B01F 23/235; B01F 33/81; B05B 7/00

(52) U.S. Cl. CPC B01F 25/4523; B01F 23/235; B01F 33/811; B05B 7/0018

(57) ABSTRACT

An injection molded component for a foaming dispenser, the component comprising: a cylindrical body (10, 100, 200) having at least one sidewall (30, 130, 230) and a top panel (20, 120) so as to define a cup-like shape; a mesh facing (21, 121, 221) integrally formed within the at least one sidewall and/or the top panel; wherein the mesh facing is formed from a first layer (24) of transversely-spaced ribs (25) positioned above a second layer (26) of transversely-spaced apart ribs (27) so that mesh apertures (50) are created by all of the ribs of the first layer intersecting at an intersection angle relative to all of the ribs of the second layer; and wherein the ribs of the first layer terminate in an upper plane (T-T) that is flush with an outer facing of the at least one sidewall and/or the top panel.

### FIELD OF THE INVENTION

This application claims priority to Italian patent application no. 102023000006747, filed on Apr. 5, 2023, which is incorporated by reference herein.

### FIELD OF THE INVENTION

This invention relates to an all-plastic fine mesh insert defining a grid of apertures defined by two sets of spaced apart ribs stacked in vertically adjacent planes. The aforementioned insert is injection molded so that the stacked mesh is formed integrally within the side walls or top panel of a cup-shaped cylindrical body. When molded, the insert is suitable for use as a modular and stackable component within a foaming dispenser. Methods of making such inserts are also disclosed.

### BACKGROUND

Dispensing pumps are useful for delivering everyday products, such as foodstuffs, soaps, and numerous other consumer products, in a convenient package that serves both as a container and a dispenser. Especially with respect to certain types of soaps and cleaning agents, suppliers prefer to dispense their product in a foamed state. Such foams can be created by mixing a pre-packaged liquid with air drawn from the ambient environment. Volumetrically, more air than liquid is normally used to form these foams, with common ratios of air:liquid ranging between 8:1 and 15:1 at preferred dispensed foam volume sizes between 0.5 and 2.0 cm³ (with 0.8 cm³ and 1.5 cm³ dose sizes being most common).

The amount of air aerated with liquid to produce foam directly impacts the number of doses a given container size can produce, as well as the characteristics of the foam itself. As more air is introduced, the foam tends to feel “drier” and may retain its shape more readily than a foam having comparatively more liquid. Accordingly, foam dispensers often require very specific dispensing conditions to produce specific characteristics for the dispensed foam.

Typically, the liquid portion of a foamed product is carried in a container, with a pump or dispensing device affixed to that container (e.g., by way of a threaded neck). These dispensers may rely on a reciprocating plunger and biasing member to create suction, or some designs rely on gravity and/or the inherent resilience of the container itself, in combination with a squeezing action by the user, to produce foams. In both instances, one or more sponges, screens, or mesh-like members are disposed in or proximate to a liquid-air mixing chamber, so as to produce the appropriate conditions for aeration and foam creation. Examples of reciprocating foam pumps/dispensers can be found in U.S. Pat. Nos. 6,053,364; 7,850,048; 8,109,415; 8,490,833; and 10,898,034, while U.S. Pat. Nos. 8,360,282 and 9,718,070 disclose squeeze and/or inverted foaming dispensers.

All of the foregoing disclosures are incorporated by reference as if fully reproduced herein. These disclosures may inform and supplement this disclosure with respect to materials selection, construction, component design, and various other aspects of this disclosure and any claims based thereon.

Conventionally, foaming dispensers tended to rely on screens or meshes made from woven or finely spaced-apart metallic wires. The metallic wires had to be ultrasonically welded or otherwise integrated onto a plastic component, thereby adding cost and complexity to the manufacture of foamer pumps.

U.S. Pat. No. 5,423,893 describes a method of injection molding meshed filter elements. These elements are produced from two-piece molds having a peripheral frame groove and a series of intersecting rib grooves, while its gates are connected to thickened, “dam/discharge ribs” positioned in the middle of the mesh in order to accommodate the flow of molten plastic and prevent it from immediately and only flowing through/around the outer frame. The resulting filter mesh may have openings spaced apart by at least 0.3 mm with diameters as small as 0.2 mm, but all disclosed embodiments require these dam/discharge ribs as semi-circular/elliptical or trapezoidal tubes with a significantly larger diameter (in comparison to the mesh netting) so as to store and distribute molten plastic. As such, these ribs must protrude significantly above and/or below the plane defined by the mesh elements, as shown best in FIG. 2 of that publication. The mesh is injection molded between a pair of flat dies with parallel grooves and larger dam sections to accommodate the gates (and possibly the edge frame, see FIG. 10). A method of using cooperating concave and convex dies is taught so as to conceal the dams along an underside/inner facing of the now-curved, molded part, although presumably the size of the dam requires it to protrude significantly out of the curved surfaces.

A “reticulated foam meshwork” is described in U.S. Pat. No. 8,109,415. This component appears to comprise a one or a series of flat, planar base members a disposed at varying angles relative to the flow path of the fluids, with shaped inlets redirecting fluid flow through these members. The base members have large, spaced-apart holes to facilitate foam formation.

As various laws continue to encourage or require consumer packaging to be fully recyclable, the need for dispensers lacking metal components (and even differing grades of polymers) are becoming more prominent. Thus, dispensers made from all-polymer (i.e., no metallic parts) and/or single-polymer (i.e., all components constructed from the same polymer or, at least, grades of polymer that are compatible for single-stream recycling) components are needed. Further, a single-polymer pump that is specifically engineered to include comparatively stiff, recyclable polymer, such as polypropylene or polyethylene, are ideal owing to those materials' ability to be easily injection-molded. Finally, a foamer that does not rely on metal wire mesh elements would be welcomed.

### SUMMARY OF INVENTION

A three-dimensional, foaming element is injection-molded, relying on a single grade of polymer, sometimes formed in a single shot. The element is formed between cooperating grooved surfaces on separate die elements along a top surface, with a further cylindrical gap allowing for an integral tubular wall to extend away from an underside of the grooved surfaces' interface. The resultant molded part has a cup-like shape with an integral, cylindrical wall (or skirt) joined to a top panel. The top panel presents a flat planar upper surface, with solid, offset spaced-apart ribs/members forming a top layer of the mesh. On the bottom, similar, spaced apart members are formed at a different angle (preferably perpendicular) so that the bottom layer of the mesh also presents a substantially flat surface. A gate-receiving area is provided at the center between the upper and lower boundaries defined by the respective ribs/members, although a cylindrical center portion can extend beneath the planar surface.

The difference in alignment of the solid members in these two discrete layers creates a regular pattern with polygonal or curvilinear through-holes spaced apart regularly. For each through-hole, junction points in which the top and bottom layers are fused together are formed at the corner of hole. This produces a fine mesh-like material that can be easily molded in the top or sides of a cylindrical, cup-like element. The gating area may be connected to a thickened dam, but the dame does not protrude above or below the top and bottom layers.

This construction produces cylindrical, cup-shaped mesh elements that are stackable and modular. Notably, the flat planes above and below the mesh ensure that fluids forced to flow through the mesh should encounter Coanda effects that produce unpredictable, turbulent flow patterns that might not otherwise arise (as if the dam element curved above the through-hole openings). As such, the modular mesh units are stacked within a pump engine so that the gate-receiving cylinder is on the bottom, “inlet side” of the mesh.

A tool and method for forming such elements are also contemplated. A first cylindrical tool part has a patterned section of spaced apart cross members on at least one of its facings. A cooperating tool part has a larger overall footprint (e.g., diameter) in comparison to the first, and a patterned section of differently aligned and spaced apart cross members is positioned in contact with the patterned section of the first tool part. When the parts are so aligned, a gap defines solid walls that will form as the skirt and/or top panel. The gap may be defined on its outermost periphery by a third tool part that coaxially receives one or both of the others. When so aligned, melted polymer is injected into the gap at one or more selected locations, and the assembly is then allowed to cool. The resultant mesh element is then ejected from the tool parts, and the process may be repeated.

A further characteristic of the invention relates to the qualities of the foam produced by the aforementioned mesh element(s). In particular and in contrast to previous attempts to create integrally formed, three-dimensional polymeric mesh elements, the foam produced by the invention is of similar characteristics to that of conventional wire-mesh foamers. It is believed that such foam is produced reliably when certain ratios of through-holes to solid facings on the two layered mesh are maintained. In particular, for every 1 mm² of opening, there should be between 25 to 30 mm² of solid material—with 27 mm² being particularly useful.

Still other aspects of the invention will be appreciated through further study of the accompanying drawings, description, and claims.

### BRIEF DESCRIPTION OF THE DRAWINGS

The appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure.

FIG. 1A is a top perspective view and FIG. 1B a corresponding bottom perspective view, both of the foamer component according to certain aspects of the invention.

FIG. 2A is top plan view and FIG. 2B a bottom plan view, both of the component of FIG. 1A.

FIG. 3 is a perspective cross sectional view of the component of FIG. 1A taken along a diameter.

FIG. 4A is an exploded cross sectional view of a portion of FIG. 3, with FIG. 4B being an identical view but taken along a section that is slight offset in comparison to FIG. 4A. FIGS. 4A and 4B help to illustrate the alignment, intersection points, and gaps that are formed by the top and bottom layers of ribs comprising the mesh.

FIG. 5A is a schematic top view of the mesh produced by aspects of the invention. FIG. 5B depicts a cross sectional plan (top) and perspective (bottom) views taken along line B-B in FIG. 5A, with a corresponding perspective view of the mesh in this configuration. FIG. 5C provides comparable alternative cross sectional configurations of the mesh taken along line B-B in FIG. 5A. FIG. 5D depicts a further alternative in cross sectional plan view taken along line B-B in FIG. 5A, with a corresponding perspective view of the mesh in this configuration.

FIG. 6A is a top perspective view, FIG. 6B a corresponding bottom perspective view, and FIG. 6C a side plan view, all of an aspect of the invention in which the mesh is formed in the sidewalls of the cylindrical component. FIG. 6D is a perspective cross sectional view and FIG. 6E a side cross sectional view, both of the component in FIG. 6A, with FIG. 6E also including an inset of an exploded sectional view highlighting the arrangement of the ribs within the mesh formed in the sidewall.

FIG. 7 includes a joined side view and complimentary exploded perspective view of the cooperating die pieces used to make the component of FIG. 3A.

FIGS. 8A through 8D are top plan views of the textured, cooperating facings of the dies depicted in FIG. 7, along with an exploded view of the mesh produced by each of these facing combinations. FIGS. 8C and 8D include exploded inset views highlighting the variable patterns produced in/by separate and discrete sections of the facings/mesh.

FIG. 9A is a top perspective view and FIG. 9B is a side plan view, both of the component of FIG. 1A and both illustrating the possible positioning of coupling features.

FIG. 10 is a cross sectional side view of an exemplary reciprocating foam dispenser, showing where a stacked foamer element (shown in an exploded view inset on the right) with axially aligned mesh facings in the top panel can be incorporated for the creation of foam.

FIG. 11 is a cross sectional perspective view of an alternative stacked foamer element having an interlocking skirt that is also appropriate for use in FIG. 10.

FIG. 12 is a cross sectional, schematic side view of a single mesh unit from the alternative stacked foamer element in FIG. 11, highlighting the integral locking features thereof.

### DESCRIPTION OF THE SELECTED EMBODIMENTS

Operation of the invention may be better understood by reference to the detailed description, drawings, claims, and abstract—all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

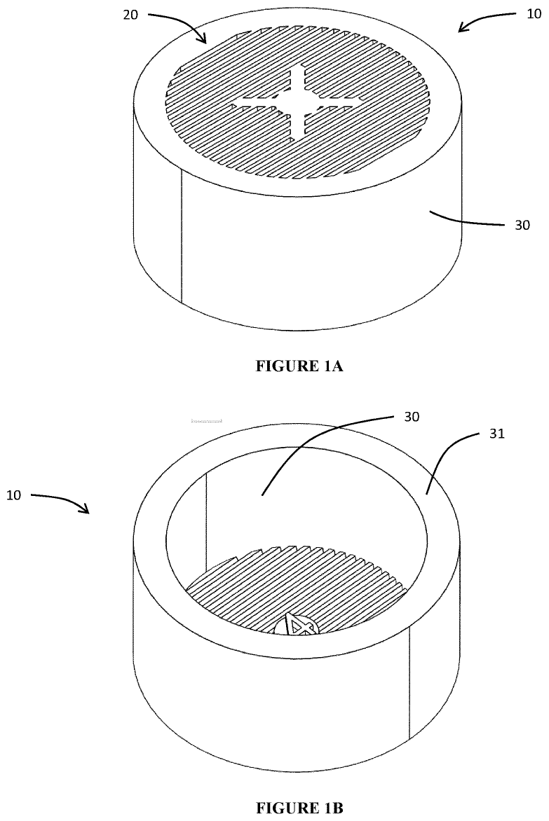

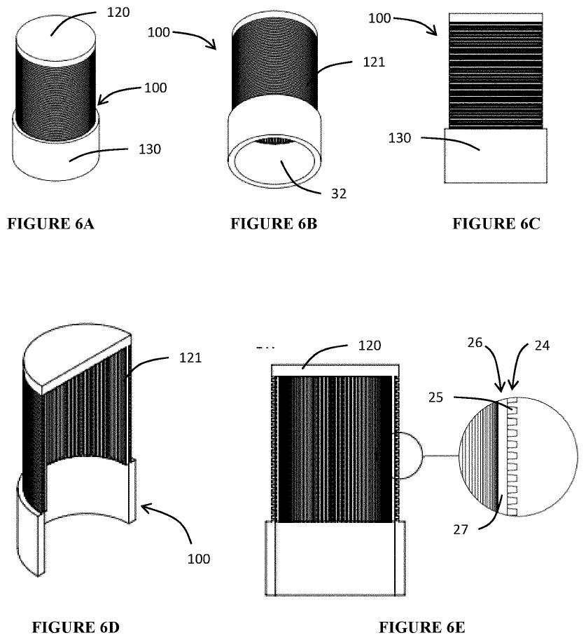

With reference to FIGS. 1A through 4B and FIGS. 6A through 6E, 11 and 12, various embodiments of the integral, one-piece molded, modular foamer element are disclosed. In all these embodiments, the element is formed as a single, integral piece, without the need for assembling and/or attaching a separate mesh to the rigid cylindrical structure. This approach eliminates the need for additional preparation and allows the element to be incorporated, as-is, into a foaming dispenser. It is also formed exclusively from one polymeric material, with an injection-molded construction that eliminates separately welded, wire screens and other disadvantages associated with conventional foaming elements for dispensing pumps.

With reference to FIG. 1A though 4B, the modular mesh unit 10 includes a top facing 20 with a cylindrical skirt 30 extending down from the periphery of the top facing 20. The skirt 30 includes sidewalls having substantially constant thickness along their height/axial length and terminating in a flattened end 31. The thickness of the skirt 30 exceeds the thickness of individual ribs and/or the combined axial height of the top and bottom layer of those ribs, both as will be described in greater detail below.

The top facing 20 includes a mesh section 21 that extends across the facing coaxially within the inner space 32 defined by the skirt 30. A centrally located, solid gating area 22 is formed in the mesh 21, while a top layer 24 and bottom layer 26 of the mesh 21 are defined by a plurality of spaced apart (preferably evenly spaced and parallel) top ribs 24 and bottom ribs 27.

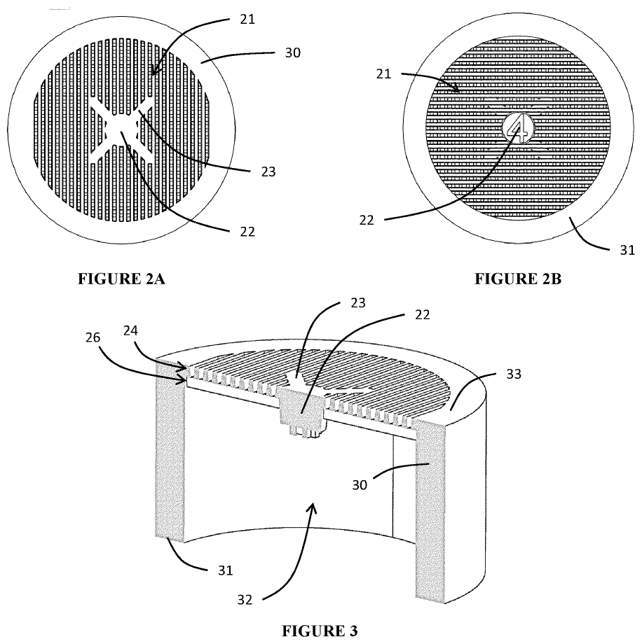

An flat but thickened plurality of dam sections 23 may be formed within the top layer 24, the bottom layer 26 or both layers 24, 26. Dam sections 23 allow for the collection and distribution of molten plastic during injection molding, although these sections will not protrude above or below the common planes defined by lines T-T on the top and lines B-B on the bottom edge surfaces of the ribs 25, 27 (respectively speaking). Preferably, the number of dam sections 23 will be limited and evenly spaced, so as to form an X-shape (shown in FIG. 2A), although a Y-shape, an “asterisks” shape and other shapes are possible, so long as the dam members are confined to the same axial height as the top layer 24 and/or bottom layer 26.

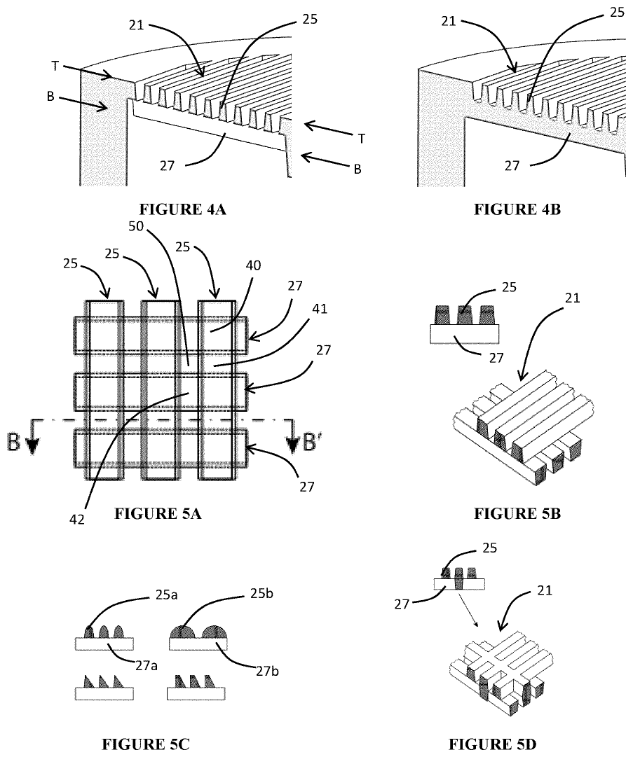

It will also be appreciated that the ribs 25, 27 are integrally formed both with the top facing 33 of the periphery of skirt 30 but also with one another along all of the points where the ribs 25, 27 overlap. That is, with specific reference to FIG. 4B, as the mesh 20 is injection molded, plastic flowing along a channel defining one of the bottom ribs 27 may freely flow up and into the channel of a top rib 25 (and vice versa). In this manner, plastic may distribute more quickly and evenly from the central gate 22, through the dams 23, and into the top layer 24 and bottom layer 26 of ribs. The resultant structure produces a surface on the ribs 25 of the top layer 24 that is completely flush and integrally formed with the top panel 20 along common plane T-T.

The gate section 22 may protrude past the bottom plane B-B and into the internal area 32 defined by the cup-shaped unit 10. This section 22 allows for an injection point for molten plastic. Notably, with reference to FIG. 3, because fluid flows through the unit 10 in an upward fashion, the fact that the gate extends below plane B-B will not create a significant and unwanted impact on the fluid exiting the mesh 20 at the top common plane T-T. That is, the orientation and intended flow pattern through the unit 10 is such that the gate 22 will not negatively impact foam quality or foam formation/performance because it is on the “upstream” side of the mesh. However, any feature protruding on the “downstream side” (i.e., above the top T-T or outlet side of the mesh 20) is likely to produce irregular and unpredictably turbulent flow patterns, especially if that feature: i) extended significantly across a majority of the mesh 20, ii) was not connected to the center gate (and, as an example, was periodically and/or irregularly positioned across the surface of the mesh), and/or iii) included a curving top surface. Because the unit 10 does not include these features, it is believed to be exceptionally well suited of use in foamers.

FIGS. 5A and 5B provide additional details on the lattice-like mesh created by the methods of this invention (and, correspondingly, the types mesh that can be integrally formed on/in the embodiments noted above). One characterizing feature of these lattices is that they effectively includes two separate layers, with a pattern of parallel or aligned ribs defining a flat top plane, and a similar arrangement—positioned at an angle (e.g., perpendicular) to the top—on the bottom facing.

As noted above, these top and bottom ribs are positioned normal to one another or at some other offset angle. The pattern of the ribs and their comparative, angled positioning defines the mesh pattern, while the overlapping or intersection point between the top and bottom ribs insures that, during the molding process, molten plastic can move freely between these structures and fuses upon cooling so that the final, molded piece is integrally formed with enhanced strength. That is, a regular pattern of axially aligned through-holes will penetrate both layers, while completely solid, overlapping top and bottom layers will be positioned at the corner of each through-hole. The flat sides of each through-hole will abut a single solid layer with a void positioned above or below it.

Notably, the two layer mesh patterns herein are characterized by ribs 25, 27 overlaid so that intersection points 40 have double the thickness in comparison to a single rib. The transversely and laterally adjacent portions 41, 42 will be of single thickness representing either only rib 25 or only rib 27. An axial through-hole or channel 50 directly penetrates through both layers 24, 26 to allow a fraction of the surface area embodied by the mesh to permit direct flow through (e.g., for a liquid passing from the interior 32 through the mesh 21 and out of the outlet defined by top panel 20). Thus, with reference to the ratio of open surface area to solid material noted above, only the channels 50 are counted as open, whereas the intersection points 40 and the adjacent portions 41, 42 are counted as solid material.

As seen in FIG. 5C, the surface shape of ribs 25a, 25b (and, possibly along the bottom in 27a, 27b) can be given curving or angled profiles. Because all of the ribs will have the same profile, the problem of differences in curvature and the possibility for turbulent or unpredictable, oscillating flow will be reduced (as described in greater detail below). Ultimately, the rectilinear embodiments, such as the trapezoids of FIG. 5B or 5D may be preferred. Also, FIG. 5D illustrates a possible arrangement in which the ribs may be offset to create larger through-holes 50 and/or selected intersection points 40 selected to impart the desired strength/bonding associated with these latter points.

The importance of the flat planar alignment of the ribs above and below the respective top and bottom layers allows for fluids to pass through the mesh (i.e., the through-holes) in a fixed manner, while minimizing contact with any protruding and/or curved surfaces on its downstream/outlet/top side. The absence of such surfaces will reduce or possibly even eliminate turbulent and unpredictable flow patterns across large areas of the molded mesh. It is believed this leads to the formation of desirable foam characteristics, as well as being useful in allowing for multiple modular mesh units to be arranged in series (i.e., stacked in-line, one on top of the other) to further enhance the desired foam characteristics required for dispensing pumps.

Further still, by relying on a single, centrally gated section on the upstream/inlet/bottom side and small dam sections contained entirely within the top and/or bottom layers of the mesh, it is possible to create extremely small through-hole apertures. The dimensions of each aperture can be less than 0.25 mm on each side and possibly as small as 0.1 mm by 0.1 mm, so that the open surface area for each aperture is less than 0.025 mm² and possibly as small as 0.01 mm². Also, for every 1 mm² of aperture surface area (i.e., open space in the mesh facing), there should be between 25 to 30 mm² of solid material—with 27 mm² being particularly useful.

In conventionally constructed foaming mesh, either a separate metallic screen had to welded to a frame (thereby producing a hybrid metal-plastic component). The inventors are unaware of any practical and effective system to date in which a foamer mesh can be produced reliably by a mold having only pins around which molten plastic may flow (and even if such molds exist, the use of pins would be extraordinarily fragile and prone to blockage or other failures).

Notably, unlike filter elements, mesh for foaming pumps must be specifically designed to allow liquid and/or air to intermix and pass through the mesh (rather than capturing unwanted particulates). Thus, the ideal foaming mesh produces a homogeneous foam with extreme small bubbles of nearly identical size. This leads to a dense foam with almost “mousse-like” qualities where the foam sits in dense circular pile after dispensing. In contrast, less effective foam (for purposes of dispenser pumps) will have bubbles of varying size and/or shape, which produces a flat, suds-like pile with ragged or ill-defined edges after dispensing.

Another way to comparatively quantify foam quality is to dispense comparable volumes of foam onto a slope surface (e.g., a glass plate held at 45°) and then observe how far the foam pile slides and how much the pile itself deforms. Desirable, higher quality foam will tend to remain more compact and will slide less in comparison to less homogeneous, less well-formed foams. In a comparative test of foam produced by modular elements of this invention and foams made by conventional wire frame foamers, the inventive foam slide only 7.5 cm in 10 seconds, whereas the conventionally produced foam slid 8.0 cm. The shape of the conventionally produced foam did not hold and, instead, became elongated or “smeared” as it travelled.

Also, in conventional foaming pumps, foaming pumps typically require multiple layers of mesh in order to produce desirable foam. These mesh layers need to be specifically tailored so that the through-hole apertures vary in size/area. For example, a current two mesh foam insert known to the inventors has a bottom mesh layer with 0.1 mm×0.06 mm holes with about 39 individual holes/mm², whereas the top mesh holes are sized at 0.06 mm×0.05 mm with about 83 individual holes/mm². Other foamers rely on as many as six mesh layers ranging for 0.10 mm×0.08 mm with about 31 individual holes/mm² to 0.25 mm×0.10 mm with only 8 individual holes/mm². Even injection molded filtering meshes found in the prior art recommend holes that are 0.5 mm wide, thereby imputing an open surface area of 0.25 mm²/opening (and with solid net material surrounding it being only 0.2 mm wide and 0.3 mm deep/high).

The cross sectional shape of each rib (with that cross section taken on an normal plane relative to the top or bottom facing) may be polygonal, triangular, semi-circular, or other profiles/shapes. In these arrangements, the cross sectional shape should remain uniform among the plurality of ribs, and the top- and/or bottom-most edge of the ribs will still define a common plane (preferably horizontally aligned) so as to insure any impact or effect of the shape on fluid flow through the mesh remains uniform and distributed evenly across the entire surface. Further, the absence of any discrete member, limited area, or feature from extending above the common plane safeguards against unwanted or unpredictable flow patterns in that discrete area.

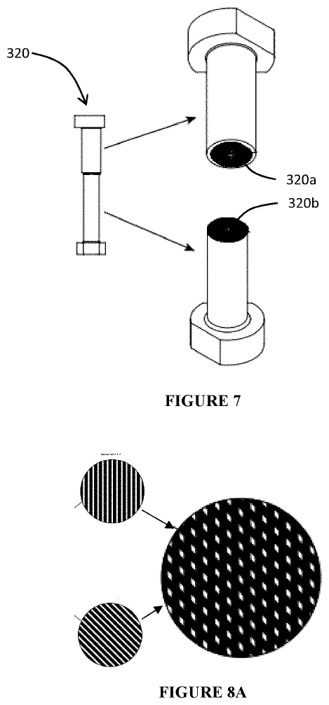

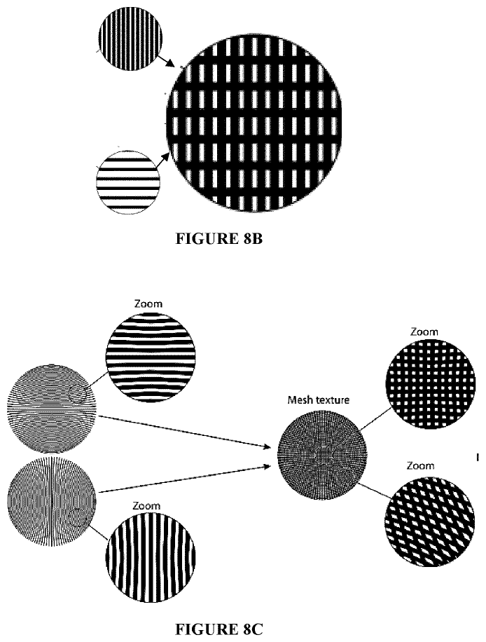

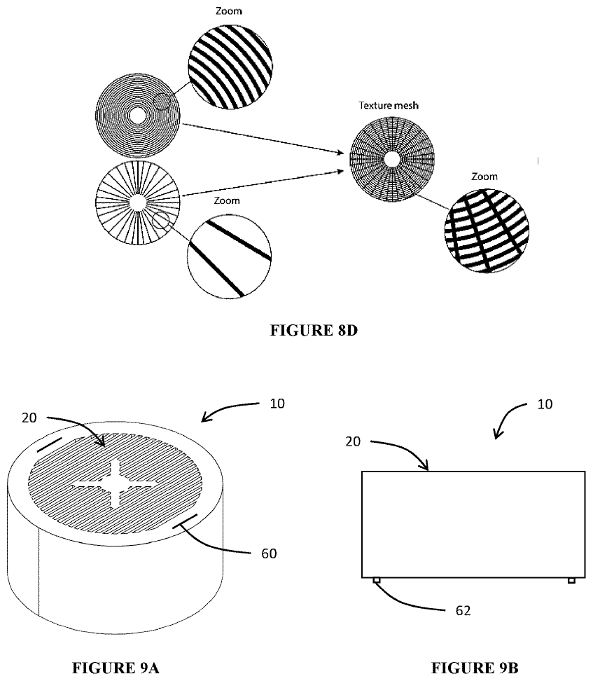

FIGS. 7 through 8D provide information on the apparatus and methods for making the molded, modular foamer element. Separate, spaced apart dies define the flow cavity for a single grade of molten polymeric material. One or both dies include gates and enhanced flow channels to insure 100% fill and complete formation of the part. The die arrangement 220 may be concentrically received in an retaining tube (not shown) to confine the flow of molten plastic and to define the sidewall upon its curing. In some aspects, the dies 220a, 220b have differing diameters so that this difference will comprise the thickness of the cylindrical sidewalls in embodiments shown in FIGS. 1A through 4B. The die arrangement 220 includes cooperating, textured facings 220a, 220b so that the lattice-like mesh can be given unique shapes, ranging from a normal-set net (e.g., FIG. 8B) to variable curves (FIG. 8C) or radial patterns (FIG. 8D).

An alternative modular mesh element 100 has the two layer mesh 121 formed in a sidewall 130 of the skirt, while the top panel 120 is a solid element. In fact, the top panel 120 can be produced to accommodate gating so as to eliminate any such obstructions within the mesh 121. Nevertheless, dam sections 123 possessing the same qualities as note above (e.g., non-protruding) could be provided.

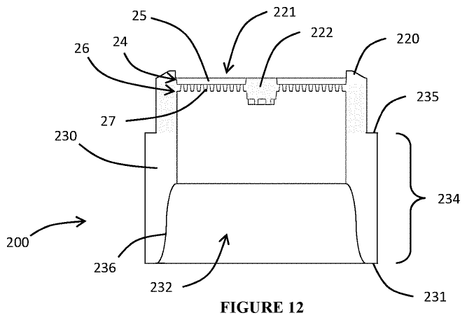

Another alternative modular mesh element 200 is shown in its stacked configuration in FIG. 11, as well as in a cross sectional side view in FIG. 12. Here, many of the features of the element 200 remain identical to those shown in modular unit 10, with a mesh facing 221 comprising a top layer 24 of ribs 25 oriented at intersecting angles in comparison to bottom layer 26 and its constituent ribs 27, as well as a gate section 222 (other elements and features of element 10 may also be incorporated into element 200). However, while the unit 200 still retains an inner space 232 that imparts a cup-like shape, the top facing 220 and the sidewall 230 have been modified to create interlocking features 234 to facilitate stacking of units as shown in FIG. 11.

First, the top facing 220 that encircles the mesh 221 has been modified with a sloping annular crown formed in regular intervals or completely around the periphery of the top panel. The slope/surface is shaped to cooperate with the inner facings of the interlock section 234 of the wall 230, as will be described below. In practice, this means that the annular ring at the periphery of the top section 230 extends axially upward at a higher elevation on the inner surface in comparison to a lower elevation at its outer edge. This results in a tapered ramp and/or a gently curving shape, whose surface can conform to the shape at the bottom 231 and along the lower edges of inner surface 236. This allows for the locking of separate units 200. In some aspects, the top most edge of the facing 220 is set axial above/away from and above the planar surface defined by the mesh section 221.

Interlocking section 234 of the wall 230 is modified in several ways to further enhance the coupling of separate units 200. First, a radial ledge 235 creates a thickened section in the middle of wall 230 to improve structural strength and to provide a landing or contact point for units 200 that can be stacked on/above the ledge 235 (see FIG. 11). Separately, the inner facing 236 along the lower most edge of the wall 230 has a tapered or S-like shape that transitions from the thicken wall section beneath the ledge 235 to a comparatively thinner wall section at the bottom edge 231. The shape or curve of the inner section 236 will conform to the top facing 220 of a stacked unit, as noted above, as well as receive and/or rest on the outer surface of the upper sections of cylindrical wall 230 on the stacked unit (again, see FIG. 11). Thus, the inner diameter at bottom 231 and along at least portions of inner surface 236 is smaller than the outer diameter of the wall 230 positioned above the radial ledge 235. It will also be understood that the inner diameter in the section 236 is progressively reduced (i.e., the wall becomes thicker) as that inner surface moves upward toward the ledge 235. In some aspects, the inner diameter of section 236 becomes constant (stops being reduced at or near the ledge 235.

In any of the configurations shown in FIGS. 1A, 6A and 12, the modular unit 10, 100, 200 has a cup-like shape with an open end formed on an opposite end of the cylinder from top panels 20, 120, 220. The lower end of the sidewall 130 or skirt 30 may include coupling formations (e.g., bead and groove, bayonet-style, etc.), with corresponding formations on the top facing of the top panel 20, 120, or the interlocking features 234 can provide enhanced strength and coupling ability. In every case, the resulting unit 10, 100, 200 can be stacked so as to allow for customized performance and foam formation according to the principles described herein.

While gate areas have been described as being positioned on the central axis, it may be possible to provide additional or alternative gate areas in the sidewall portion, in which case the dam sections could be eliminated or provided in close proximity to the gate so as to serve as reservoirs as the part is initially molded. Also, as shown in FIG. 1B, gate area 22 can instead be imparted with identification indicia that becomes filled during the molding process.

Owing to the molding methods described herein, the ribs 25, 27 are primarily formed separately by molten polymer flowing into and along the length of each rib. However, because the ribs 25, 27 abut one another, their intersection points within the mesh 21 represent areas where molten polymer mixes and fuses together during the molding process. Thus, when the part is cured and cooled, the mesh 21 includes bonded sections between the ribs 25, 27 as well as along the peripheral edge 33 where the mesh 21 integrates with the top panel 20 and skirt 30. In some aspects, ribs 25 will have identical dimensions (width, height, and cross sectional shape) to ribs 27. Also, in some aspects each and every rib 25, 27 will be the same as the ribs immediately adjacent to it in the top or bottom plane.

Flow ribs 23, when present, need only be formed on the top or bottom facing. Flow ribs 23 will conform to the planar facing B-B and/or T-T. The flow ribs 23 preferably radiate from the gate(s) section 22 in a regular pattern (e.g., X-shape or multi-pronged “starburst” shapes, preferably with anywhere from 3 to 8 evenly spaced and similarly-dimensioned “arms”). In so doing, flow ribs 23 also intersect the planar ribs 25 and/or 27 at a non-orthogonal angle, as this arrangement “feeds” molten polymer that builds up within the flow rib 23 to a larger number of intersecting planar ribs. While shown on the top facing in FIGS. 1A through 4B, flow ribs could be provided on the bottom facing. It is also possible to provide separate gates on both the top and bottom facings, in which case flow ribs 23 will be located in differing regions of the mesh 21, with some ribs 23 being coplanar with the top and others being coplanar with the bottom facing). Ribs 23 are expected to have the most utility when provided to flat wall sections, although it may be possible to form them within curved sections of sidewalls.

Another advantage and characteristic of the foaming mesh contemplated herein is that the axial height/travel distance through one of the layers 24, 26 will be at least two and one half times greater than the comparative width of the through-holes 50 defined at and by the interfaces of ribs 25, 27. That is, similar to the ratios of open area to blocked area noted above, only a small fraction of the surface are for the foaming mesh needs to be open/allow for fluid flow. Notably, because the purpose of the mesh is to produce foam, the structure does not need to maximize through-put or otherwise provide for capture of particulates (as might otherwise be the case for filtering mesh). Thus, the structures produced and described herein are directed to the specific exigencies of foaming mesh.

While the mesh 21, 121, 221 is illustrated as forming a uniform, orthogonally intersecting net in FIGS. 1A through 6E, FIGS. 8A through 8D provide alternative arrangements (in addition to exemplifying the textured surfaces that must be imparted on the interfacing die surfaces 220a, 220b to realize those arrangements/patterns). In FIG. 8A, linear and parallel grooves in the die coupling 106 will produce the pattern shown in FIG. 5A when the grooves of surface 220a are rotated at 90° to those of surface 220b. When the rotation is not 90° (e.g., as indicated in FIG. 8A) the resultant pattern has regularly spaced, diamond shaped apertures with reduced open through-area in comparison to the pattern of FIG. 5A. Thus, simply by changing the angle of intersection for the ribs 25, 27 that form between the grooves of 320a, 320b, the amount of open area and, therefore, the amount of fluid that pass through the mesh 21, 121, 221 can be altered within any changes to the tooling.

In FIG. 8B, one of the die surfaces B2 is altered to have larger spacing between the grooves. This produces any of the various patterns illustrated here, in which the apertures are comparatively larger (with a rectangular shape) and, therefore, provide for greater fluid pass through than the pattern of FIG. 5A. Additionally, surfaces 320a, 320b can be rotated similar to FIG. 8A to further adjust the shape and spacing of the apertures.

FIGS. 8C and 8D provide examples in which the grooves are not parallel. For example, configurations in FIG. 8C have similar patterns in which only the central groove in the array is a straight line. The grooves on either side of center curve, preferably in a regular increasingly pronounced (i.e., the arc increases as the grooves move further away from the center). This arrangement produces a variable aperture pattern, where the size and spacing of the apertures varies across the facing. As with FIGS. 8A and 8B, surfaces 320a and 320b can be angled relative to one another to produce and further control the variations in pattern and overall open area available for fluid pass through.

In FIG. 8D, the grooves are concentric circles (although ovals or progressively larger, radiating polygons or closed shapes could also be used), with an opposing a radial groove pattern (as shown, the grooves have variable distances around the circumference, although these could be spaced evenly). The resultant pattern creates a “spider web” effect, with larger, arc-shaped apertures near the edges and lesser surface area at the center.

Any of the aforementioned patterns may be incorporated into the surfaces 320a, 320b to produce meshes in/on the units 10, 100, 200 of FIGS. 1A through 6E, 11, and 12. A key characterizing feature in each is that the top or outer facing ribs (and, when present, flow ribs) are only aligned within that top/outer facing plane or surface, whereas the bottom or inner facing ribs—which are aligned at an intersecting angle to the top/outer ribs—are only aligned in the bottom/inner facing plane or surface. The resulting a foaming element operates on par (if not better than) conventional woven mesh or other foaming elements. Further, the ability to stack the elements in a modular fashion enables a manufacturer to adjust foam properties without the need to create new tooling.

Although not shown in FIGS. 8A through 8D, entry gates and/or dams can be formed at the center or in any pattern along the surface. Also, the two dimensional representations in FIGS. 8A through 8D should not be mistook for contiguous surfaces, and only ribs 25 will be formed via the top facing 320a, while only ribs 27 be formed via the bottom facing 320b.

This arrangement of ribs in the various aspects of invention stands in stark contrast with woven meshes, in which orthogonal strands alternate to form warp and weft strands. This arrangement is also in contract to more conventional “net” structures in which substantially all of the ribs forming the mesh are planar to both the top and the bottom facings (or, as shown in U.S. Pat. No. 5,423,893, where the flow ribs protrude substantially beyond the facings of the mesh, so that the flow ribs define top and/or bottom planar facings, thereby inducing a Coanda effect to fluid passing through the mesh). It should also be noted that these conventional net structures are more easily formed by punching out apertures from a solid sheet, as previous attempts to injection mold this type of net can be complicated by uneven or impeded flow through the “net structure.”

The die pieces 320 accommodating the textured surfaces 320a, 320b are fitted together to form assembly so that the interfacing surfaces come into direct contact with one another, thereby closing off the grooves and, ultimately, defining the voids in which ribs 25, 27 (and, if present, flow ribs 23) are formed. The assembled die is concentrically fitted within an appropriately sized hollow tube (not shown) which defines the voids that form sidewalls/skirt.

Thus, a method of making a foam mesh element is contemplated. This method involves creating solid, circular die components of varying diameters, wherein the difference in diameter is selected to create the desired thickness in a sidewall of the element and wherein each die component has a cooperating textured surface. The circular die components are formed or confined within a hollow tube so that the cooperating textured surfaces are in direct contact with one another. A single grade of molten polymer, preferably selected to match the materials used to construct the overall dispenser pump, is injected at one or more gates provided in one or both of the die components so that molten polymer completely fills all void spaces between the die components and, when present, the hollow tube. The molten polymer is allowed to cool so that a unitary cup-shaped element with a lattice-like mesh is produced along the interface of the cooperating textured surfaces. In some aspects, the orientation of cooperating dies is rotated to increase or decrease the open area in the lattice-like mesh.

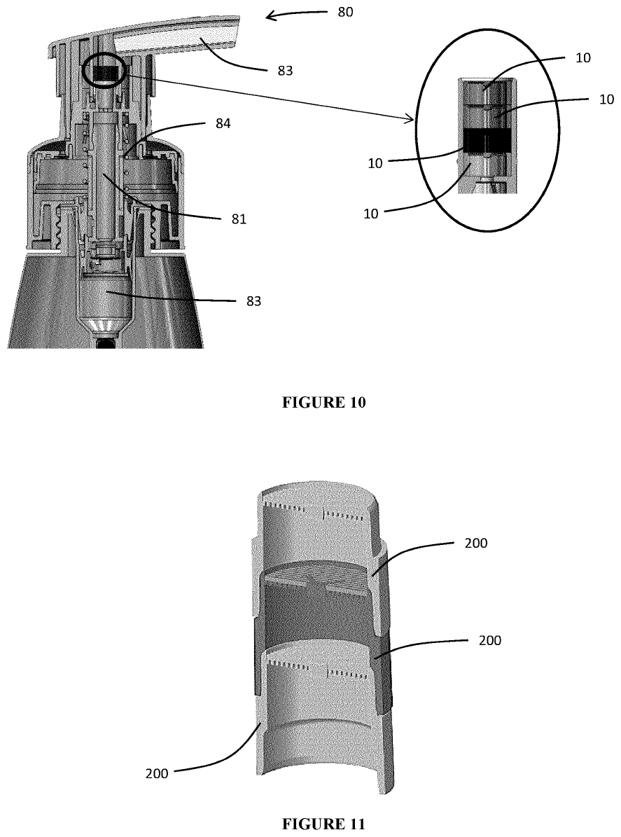

Further, methods of using one element or stacked unit of multiple elements to make foaming dispensers and/or foamed products are contemplated. With reference to FIGS. 9A through 10, the elements may be injection molded according to the procedures described herein, and the elements 10 include coupling features 60, 62 (e.g., bead and groove, bayonet style protrusions, etc.) on their intended, interfacing surfaces so as to allow multiple elements 10 to be assembled in a stack set of units and provided to a foaming dispenser. In the same manner, the interlocking features 234 and/or annular sloping crown in the top facing 220 of multiple units 200 also allow for easy assembly and stacking as described above.

A stack of anywhere from 1 to 4 discrete components 10 are positioned within a dispensing channel 81 of reciprocating pump 80 so that substantially all of the liquid in the dispenser passes through the mesh(es) of the element/stack. The pump 80 possesses a pump chamber 82, a dispensing nozzle 83, a biasing member 84, and other components commonly found in foam-dispensing pumps (see U.S. Pat. No. 11,040,365, which is incorporated by reference herein). Air is introduced at, upstream, or downstream of the element/unit so that foam is produced.

The disclosures incorporated above in regard to all-plastic biasing members and, separately, various rotational locks, catch mechanisms, and other sealing strategies for a reciprocating pump are appropriate for use with the inventive assembly 100. Similarly, any conventional container that can be coupled to a pump closure is suitable for use with pumps incorporating the assembly 100.

While any combination of the foregoing features can be used to define the invention, preferred aspects will include an injection molded component that can be used in a foaming dispenser. This component is characterized by a cylindrical body having at least one sidewall and a top panel so as to define a cup-like shape; a mesh facing integrally formed within the at least one sidewall and/or the top panel; wherein the mesh facing is formed from a first layer of transversely-spaced ribs positioned above a second layer of transversely-spaced apart ribs so that mesh apertures are created by all of the ribs of the first layer intersecting at an intersection angle relative to all of the ribs of the second layer; and wherein the ribs of the first layer terminate in an upper plane that is flush with an outer facing of the at least one sidewall and/or the top panel. Additional aspects may include any one or combination of the following optional features:
wherein each of the ribs of the first layer and the second layer are integrally fused together at intersection points;
wherein a gate section is provided within the mesh so as to extend below a lower plane defined by the ribs of the second layer;
wherein flow ribs are formed within the first layer and/or the second layer so as to remain confined between the upper plane and the lower plane;
wherein the flow ribs radiate from the gate section in a regular pattern of spaced apart arms;
wherein the apertures has a square or rectangular shape;
wherein the intersection angle remains constant across all of the mesh facing;
wherein the intersection angle is ninety degrees;
wherein the ribs in the first layer and/or the ribs in the second layer are curved;
wherein the mesh facing has a spider web pattern;
wherein the intersection angle taken in a first region of the mesh facing is different in comparison to the intersection angle taken in a separate region of the mesh facing;
wherein the ribs in the first layer have a cross sectional shape that is polygonal or curved and wherein an upper-most tangent point of the cross sectional shape of each rib defines the upper plane;
wherein the ribs in the first layer and/or the ribs in the second layer have a cross sectional shape selected from polygonal, curved, triangular, trapezoidal, and semi-circular;
wherein a ratio of open surface area in the mesh facing to solid material surface area in the mesh facing is between 1:25 and 1:30 and, more preferably, about 1:27;
wherein an open surface area for each aperture is greater than or equal to 0.01 mm² and less than 0.025 mm²;
wherein the axial height of the mesh facing between the upper plane and the lower plane is more than two and one half times larger than a width of the largest aperture(s) of the mesh facing;
wherein the sidewall includes interlocking features at its lower extremities, optionally including an outer radial ledge and/or a tapered inner surface; and
wherein the top panel includes a sloping annular crown encircling an outer periphery of the mesh facing, optionally with the sloping annular crown conforming to portions of the tapered inner surface.

A foaming dispenser pump using one or a plurality of the aforementioned elements is also contemplated. The elements may be stacked and coupled together relying upon coupling features formed on the cylindrical body of each element and, more specifically on the interfacing surfaces typically on the top panel and bottom edge of the skirt/cylindrical wall.

All components of the pump dispenser should be made of materials having sufficient flexibility and structural integrity, as well as a chemically inert nature. Certain grades of polypropylene and polyethylene are particularly advantageous, especially in view of the absence of any thermosetting resins, elastomeric polymer blends, and other chemically distinct polymers or copolymers (in comparison to the other components of the dispensing pump). Notably, high density polyethylene (i.e., having a density of greater than 0.940 g/cm³) possesses certain advantages over lower density polyethylene types (e.g., medium density at 0.925 to 0.940 g/cm³ and/or lower density at 0.880 to 0.925 g/cm³), as well as allowing for consideration of other specialized, stiffer versions capable of cross-linking.

References to coupling in this disclosure are to be understood as encompassing any of the conventional means used in this field. This may take the form of snap- or force fitting of components, although threaded connections, bead-and-groove, and bayonet-style/slot-and-flange assemblies could be employed. Adhesive and fasteners could also be used, although such components must be judiciously selected so as to retain the recyclable nature of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

1. An injection molded component for a foaming dispenser, the component comprising:
a cylindrical body having at least one sidewall and a top panel so as to define a cup-like shape;
a mesh facing integrally formed within the at least one sidewall and/or the top panel;
wherein the mesh facing is formed from a first layer of transversely-spaced ribs positioned above a second layer of transversely-spaced apart ribs so that mesh apertures are created by all of the ribs of the first layer intersecting at an intersection angle relative to all of the ribs of the second layer; and
wherein the ribs of the first layer terminate in an upper plane (T-T) that is flush with an outer facing of the at least one sidewall and/or the top panel.

2. The component of claim 1 wherein each of the ribs of the first layer and the second layer are integrally fused together at intersection points.

3. The component of claim 1 wherein a gate section is provided within the mesh facing so as to extend below a lower plane defined by the ribs of the second layer.

4. The component of claim 3 wherein flow ribs are formed within the first layer and/or the second layer so as to remain confined between the upper plane and the lower plane.

5. The component of claim 4 wherein the flow ribs radiate from the gate section in a regular pattern of spaced apart arms.

6. The component of claim 1 wherein at least one of the mesh apertures has a square or rectangular shape.

7. The component of claim 6 wherein the intersection angle remains constant across all of the mesh facing.

8. The component of claim 7 wherein the intersection angle is ninety degrees.

9. The component of claim 1 wherein the ribs in the first layer and/or the ribs in the second layer are curved.

10. The component of claim 9 wherein the mesh facing has a spider web pattern.

11. The component of claim 9 wherein the intersection angle taken in a first region of the mesh facing is different in comparison to the intersection angle taken in a separate region of the mesh facing.

12. The component of claim 1 wherein the ribs in the first layer have a cross sectional shape that is polygonal or curved and wherein an upper-most tangent point of the cross sectional shape of each rib defines the upper plane.

13. The component of claim 1 wherein the ribs in the first layer and/or the ribs in the second layer have a cross sectional shape selected from polygonal, curved, triangular, trapezoidal, and semi-circular.

14. The component of claim 1 wherein a ratio of open surface area in the mesh facing to solid material surface area in the mesh facing is between 1:25 and 1:30.

15. The component of claim 1 wherein an open surface area for each mesh aperture is greater than or equal to 0.01 mm² and less than 0.025 mm².

16. The component of claim 1 wherein an axial height of the mesh facing between the upper plane and a lower plane defined by the ribs of the second layer is more than two and one half times larger than a width of any of the mesh apertures.

17. The component of claim 1 wherein coupling features are provided on the cylindrical body.

18. The component of claim 1 wherein interlocking features are provided on one or both of the top panel and the at least one sidewall.

19. The component of claim 1 the interlocking features include at least one of: a sloping annular crown encircling an outer periphery of the mesh facing and an outer radial ledge and/or a tapered inner surface on the sidewalls.

20. A foam dispensing pump having a plurality of the components of claim 17 coupled together to form a stacked foaming element.
